(19) United States
(12) Patent Application Publication
(10) Pub. No.: US 2013/0055849 A1
(43) Pub. Date: Mar. 7, 2013

(54) STEERING APPARATUS THERMAL MANAGEMENT

(71) Applicants: Arunachala Parameshwara, Bangalore (IN); Ankit Kumar Garg, Bangalore (IN); Triloka Chander Tankala, Bangalore (IN); Sudhakar Ramamoorthy Marur, Bangalore (IN); Poovanna Theethira Kushalappa, Bangalore (IN)

(72) Inventors: Arunachala Parameshwara, Bangalore (IN); Ankit Kumar Garg, Bangalore (IN); Triloka Chander Tankala, Bangalore (IN); Sudhakar Ramamoorthy Marur, Bangalore (IN); Poovanna Theethira Kushalappa, Bangalore (IN)

(73) Assignee: SABIC INNOVATIVE PLASTICS IP B.V., Bergen op Zoom (NL)

(21) Appl. No.: 13/226,099

(22) Filed: Sep. 6, 2011

(51) Int. Cl. B62D 1/06; B21D 53/26

(52) U.S. Cl. 74/558; 29/894.1

(57) ABSTRACT

A steering wheel system can comprise: an armature comprising a rim comprising a plastic core, a covering between the plastic core and the protective outer layer, and a thermal management provision; a hub with a bush; and a spoke connecting the rim to the hub. A method for making a thermal management steering wheel can comprise: forming a plastic rim with a core having a channel with ribs, wherein during use, the ribs induce a change in direction and a change in velocity of a fluid flow through the channel; laser direct structuring electrically conductive material onto the core; disposing a foam material around the core; and disposing a protective material around the foam material.

### BACKGROUND

The present disclosure relates generally to steering wheels, and especially to steering apparatus thermal management.

Vehicles are often exposed to temperature extremes. For example, during winter months, the vehicle can be exposed to below freezing temperatures. In general during extreme cold weather conditions, the steering wheel of the car goes to sub zero temperature. When a driver switches on the heater, the cabin air temperature can raise to a comfort temperature within certain span of time. However, in this same time, the surface temperature of the steering wheel may not reach the comfort temperature.

Similarly, during summer months, or when used in warm climates, the vehicle can be exposed to high temperatures (e.g., exceeding 100° F. (38° C.). In general during extreme high temperature conditions, the steering wheel of the car becomes uncomfortably hot to touch, particularly when the steering wheel is a dark color (e.g., black). When a driver switches on the air conditioning, the cabin air temperature can decrease to a comfort temperature within certain span of time. However, in this same time, the surface temperature of the steering wheel may not reach the comfort temperature.

In more extreme situations, the vehicle has limited or no cabin (e.g., farm and/or construction equipment). As a result, the steering wheel can be frozen or too hot to grasp. In these situations, the temperature of the steering wheel is more than a comfort issue; functionality of the vehicle is affected.

What is needed is a steering wheel system that can bring the steering wheel at least close to the comfort temperature in a short span of time.

### BRIEF DESCRIPTION

Disclosed, in various embodiments, are steering apparatus and methods for thermal management of steering apparatus.

In an embodiment, a steering wheel system can comprise: an armature comprising a rim comprising a plastic core, a covering between the plastic core and the protective outer layer, and a thermal management provision; a hub with a bush; and a spoke connecting the rim to the hub.

In an embodiment, a method for making a thermal management steering wheel can comprise: forming a plastic rim with a core having a channel with ribs, wherein during use, the ribs induce a change in direction and a change in velocity of a fluid flow through the channel; laser direct structuring electrically conductive material onto the core; disposing a foam material around the core; and disposing a protective material around the foam material.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic view of an exemplary heated steering wheel (“SW”) system including a temperature control module (which could be the HVAC control module).

FIG. 2 is a partially cut-away perspective view of an embodiment of a steering wheel showing the engineered thermoplastic base, printed heater, and protective outer layer.

FIG. 2A is an enlarged view of a portion of the steering wheel of FIG. 2 illustrating the printed heater and plastic wheel.

FIG. 2B is an enlarged view of a portion of the steering wheel of FIG. 2 illustrating the optimization of printed heater on plastic wheel

FIG. 2C is an enlarged view of a portion of the steering wheel of FIG. 2 illustrating bus-bar design.

FIG. 3 is a partial, cut-away view of another embodiment of a steering wheel which can be formed in multiple (e.g., 2), pieces.

FIG. 3A is an enlarged view of a portion of the steering wheel of FIG. 3 illustrating a designed air flow channel through the steering wheel.

FIG. 3B is an enlarged view of a portion of the steering wheel of FIG. 3 illustrating an alternate design for the airflow channel through the steering wheel.

FIG. 3C is an enlarged view of a portion of the steering wheel of FIG. 3 illustrating an alternate design for the airflow channel through the hollow steering wheel.

FIG. 4 is a cross-sectional, perspective view of an embodiment of a steering wheel system comprising a diverter for diverting air from the heating, ventilation, and air conditioning (HVAC) system through the steering wheel.

FIG. 4A is an enlarged view of the connector from FIG. 4 attaching the steering wheel rotating element to an air receiving cover.

FIG. 5 is a cut away perspective view of another embodiment of a steering wheel with electrically and thermally conductive foam located around an engineered e.g., thermoplastic) core.

FIG. 6 is a front, cut away perspective view of another embodiment of a steering wheel that uses flexible tubes to enable fluid to flow through the steering wheel.

FIG. 6A is a cross-sectional view of the steering wheel illustrating the arrangement of the plastic core, conduit, and covering in FIG. 6.

FIG. 6B is a backside enlarged cut away view illustrating the plastic core, conduit, and covering from FIG. 6.

FIG. 7 is a front, cut away perspective view of the steering wheel that uses electrically conductive second shot material

FIG. 7A is a cross section of first shot thermoplastic core showing the receptacles for the second shot material

FIG. 7B is a cross section view of the FIG. 7 showing core, second shot material and the protective covering.

FIG. 8 is a perspective view of an embodiment of an armature including a hub and bush.

FIG. 8A is a cross-sectional view of the rim from FIG. 8, taken along the dashed lines.

FIG. 9 is a graphical representation of the time needed to reach a temperature of 32° C. on an upper surface of a steering wheel comparing the flow path designs of FIGS. 3A-3C.

FIG. 10 is a graphical representation of the average surface temperature on a steering wheel rim versus time for a plastic rim with a printed heater circuit on the rim with a foam outer surface.

### DETAILED DESCRIPTION

Disclosed, in various embodiments, are thermal management of steering apparatus and systems. These systems allow for more efficient and effective heating (and/or cooling) of a steering wheel compared to only convective heat transfer from cabin air. Generally, the system comprises an engineered steering wheel structure (e.g., such that the armature can be free of metal, including metal core, frame, or coating, but optionally including a metal hub and/or bush) with a heat source communicating therewith. The steering wheel can be in operational communication with a temperature control module (e.g., the HVAC control module for the vehicle and/or a separate temperature control module). When the vehicle is started, the temperature of the steering wheel can be determined and, if appropriate, can be adjusted to a chosen temperature (e.g., a comfort temperature). The heat source can comprise an electrically conductive heating elements (e.g., a grid of electrically conductive ink, paste, and/or thermoplastic) on the engineered wheel, the wheel can be hollow such that a fluid can flow though the wheel and provide thermal adjustment (e.g., heating and/or cooling), and/or the wheel can comprise a thermally conductive foam around the core.

In the various embodiments, the thermally managed steering apparatus is disclosed. For example, electrical energy is supplied from the battery of the car. The power supply to the heating elements is linked to HVAC (Heating Ventilation and Air Conditioning) of the car. Battery will supply electrical energy to the heat element. A control mechanism is provided to regulate the power supply to the heating element. The materials employed are electrically and thermally conductive. By virtue of the heating system design, the electrical energy will be converted into heat. Since the heating elements are connected to the steering wheel, the steering wheel gets heated up quickly. Based on the rate of heating desired, the electrical resistivity can be selected. A low resistivity indicates a material that readily allows the movement of electrical charge within the conductor. The resistivity/conductivity can be determined from the volume of the conductor, the cross section of the conductor, applied voltage, and the amount of heat output desired. The heating elements can have a resistance of greater than or equal to 1.0×10⁻⁵ ohm-centimeter (ohm-cm). For conductive polymers, for example, the resistivity can be 102 to 109 ohms per square (ohms/sq).

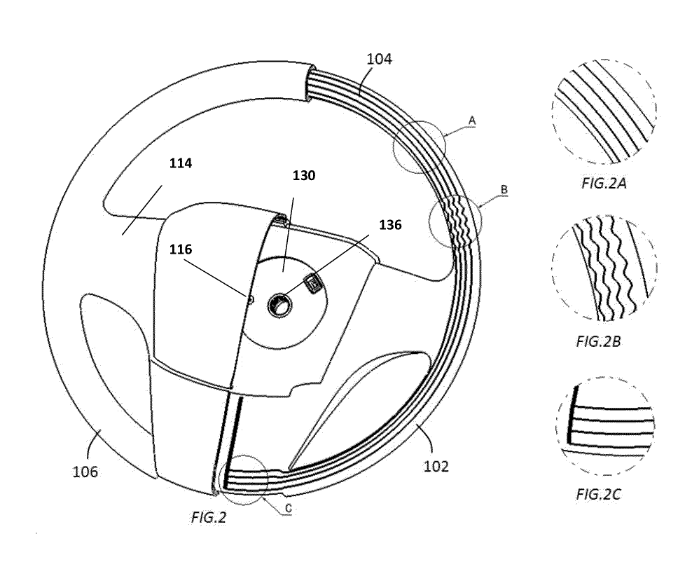

In one embodiment, e.g., illustrated in FIGS. 2, a heater trace (e.g., capable of supplying heat energy of greater than or equal to 5 Watts (W), specifically, greater than or equal to 20 W) can be applied to an engineered core of a steering wheel. This design is simple, can be a single or multi-piece core, and adds only negligible weight to the steering wheel system. Furthermore, since the shape, number, and spacing of the heating element (e.g., heater traces) can be designed to attain a desired heat distribution, the heat density can be controlled and, if desired, chosen areas (e.g., grip areas) can be designed to be adjusted more quickly than other portions of the steering wheel as illustrated in FIG. 2C. In this design, the heater traces can be covered, such as with leather, vinyl (e.g., faux leather), foam, and so forth, as well as combinations comprising at least one of the foregoing.

The engineered core can comprise a plastic, e.g., thermoplastic, thermoset, and combinations comprising at least one of the foregoing. Depending upon the particular use (e.g., passenger vehicle, commercial equipment (farm equipment, construction equipment, etc), and so forth), such as any thermoplastic that is deformable and absorbs energy during an impact event. Specifically, examples of possible plastics include a desired strain to failure rating (e.g., for passenger vehicles, those having a greater than or equal to 20 percent strain to failure rating as measured by tensile testing in accordance with ASTM D-638; e.g., for passenger vehicles, those having a greater than or equal to 2 percent strain to failure rating as measured by tensile testing in accordance with ASTM D-638), and/or having elastic deformation at low loads and plastic deformation at high loads, wherein low loads are characterized as those encountered during normal operation of a steering wheel, and high loads are characterized as severe abuse or impact events as defined under Federal Motor Vehicle Safety Standard 203. Examples of possible plastics include poly(arylene ether) resins, polyimides (e.g., polyamideimides, polyetherimides), polysulfones (e.g., polyether sulfones, polyaryl ether sulfones, polyphenylene ether sulfones), nylon, polyester, acrylonitrile-butadiene-styrene (ABS), polycarbonate (e.g., LEXAN* resin commercially available from SABIC Innovative Plastics), phenylene ether resins, polyphenylene oxide, polyamides, phenylene sulfide resins, polyvinyl chloride PVC, high impact polystyrene (HIPS), olefins (e.g., thermoplastic olefins (TPO), low/high density polyethylene, polypropylene), and foamed materials thereof, as well as combinations comprising at least one of the foregoing, such as polycarbonate/ABS blend, a copolycarbonate-polyester, acrylic-styrene-acrylonitrile (ASA), acrylonitrile-(ethylene-polypropylene diamine modified)-styrene (AES), polyphenylene ether-polystyrene, and silicone modified polycarbonate, commercially available from the SABIC Innovative Plastics under the trademark LEXAN* EXL (e.g., LEXAN* EXL 1406, a glass fiber reinforced polycarbonate-siloxane copolymer). It is noted that, besides the hub and bush (e.g., that attach the steering wheel to the steering column, the steering wheel can be all plastic (e.g., thermoplastic, thermoset, or a combination comprising at least one of the foregoing).

In addition to the plastic, the plastic can include various additives, fillers, reinforcing agents, ordinarily incorporated into polymer compositions of this type. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a heat stabilizer, mold release agent, and ultraviolet light stabilizer. In general, the additives are used in the amounts generally known to be effective. The total amount of additives (other than any impact modifier, filler, or reinforcing agents) is generally 0.01 to 5 wt %, based on the total weight of the composition.

Possible fillers or reinforcing agents include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates), talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well combinations comprising at least one of the foregoing fillers or reinforcing agents. The fillers and reinforcing agents can be in the form of particles, spheres, a mat (woven or non-woven), fibers, coated with a layer of metallic material to facilitate conductivity, or surface treated with silanes to improve adhesion and dispersion with the polymeric matrix resin. Fillers are used in amounts of 1 to 200 parts by weight, based on 100 parts by weight of based on 100 parts by weight of the total composition.

The other material for second shot material is of PTC (positive temperature coefficient) material which can regulate the temperature itself without the need for additional controllers.

In addition to the plastic can further be combined with various additive(s), with the proviso that the additive(s) are selected so as to not significantly adversely affect the desired properties of the thermoplastic composition, in particular its mechanical, thermal, rheological, magnetic, processing, optical, acoustical and other relevant and critical properties. Combinations of additives can be used. Such additives can be mixed at a suitable time during the mixing of the components for forming the composition

Possible fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as titania (TiO₂), aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon (e.g., carbon black, graphite, etc.), glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper, steel, and nickel, gold, or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents. In one embodiment, carbon fibers, carbon nanofibers, carbon nanotubes, carbon black, or a combination comprising at least one of the foregoing can be used, with mineral fillers, glass fibers, carbon fibers, and combinations comprising at least one of the foregoing typical.

The foam can comprise any of the above plastics that can be foamed and will retain the desired structural integrity once foamed. An example of possible foams include conductive polyurethane foam with additives to make it thermally conductive or to make it thermally and electrically conductive. The foam can also be formed from silicon based and/or expanded polyethylene or expanded polystyrene.

Here, the heating element, which is designed to receive an electrical current, is deposited directly onto the thermoplastic armature. These heating elements (e.g., formed of conductive ink, paste, polymer, film, or a combination thereof) can be discrete units, e.g., in the form of lines. The lines can be deposited on the surface (e.g., locally or in continuous form around/throughout the rim), and/or inside a hollow section of the armature. The path of the heating elements can be designed to improve thermal management efficiency (e.g., heating), in the area where an operator will first grip the steering wheel. An example of a conductive ink includes metallic pigmented inks comprising pigments of silver, copper, zinc, aluminum, magnesium, nickel, tin, silicon, or a combination comprising at least one of the foregoing. Examples of conductive polymers include but are not limited to polyaniline and polythiophene (i.e., Baytron* polymers, H.C. Starck GmbH, Germany). Conductive films can comprise indium tin oxide (ITO), indium doped zinc oxide (IZO), aluminum doped zinc oxide, and a combination comprising at least one of the foregoing.

In addition or alternative to printing the heating element onto the armature, the heating element can be applied in a two shot molding process as the second shot. Optionally, the heating element can be located in grooves in the armature, e.g., that will help protect the heating element from damage. The geometry of receiving groves in the armature can be designed to distribute the thermal energy from the heater elements to the surface of the steering wheel in a desired fashion (e.g., uniformly).

In the various designs employing the heating element (e.g., ink, and/or electrically conductive thermoplastic), the system can be designed such that only one pair of electrodes is needed to supply the electricity to the heating element. This simplifies the design and enhances efficiency. The heating elements can be printed onto the steering wheel rim such that the conductive lines extend between bus bars. The bus bars can then, in turn, be in communication with an electrical source capable of supplying electrical power to the conductive lines. In various embodiments, the heater element can be formed using a LDS (laser direct structuring) method.

The armature design can be either hollow (e.g. closed hollow) or solid section achieved either by joining two (e.g., clam shell) or more than two pieces together, or through injection molding (e.g., gas assisted injection molding, water assist injection molding, etc.), or an open section depending upon the load conditions the armature has to meet.

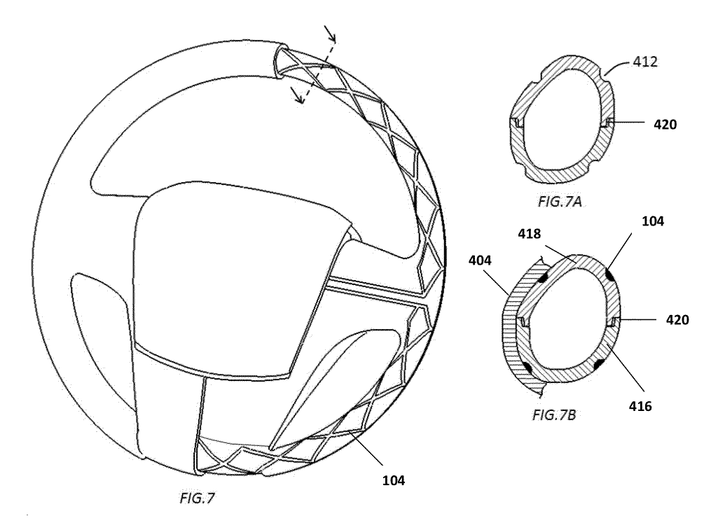

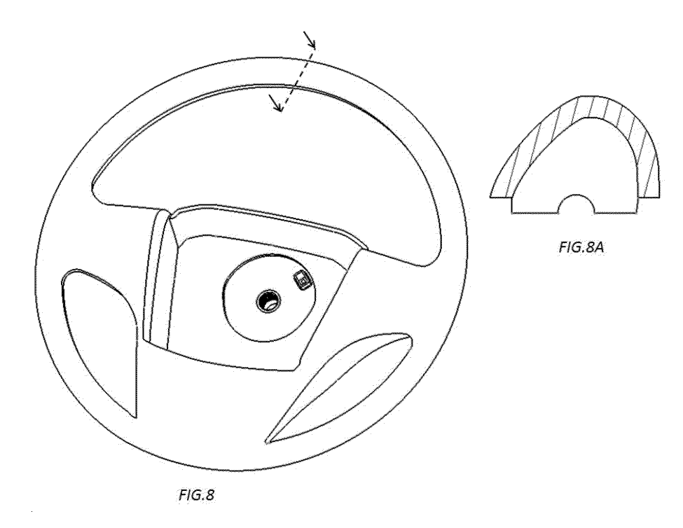

The thermoplastic armature can contain receiving groves to protect the heating elements from deterioration due to regular functioning of steering wheel. These groves can also be used to make a seamless design (no projection outside the core such as in FIG. 7B) for leather wrapped or without any wrapping over the steering wheel rim.

Second protective layer can be applied over the heater element. Various processes can be used to apply the protective layer; e.g., injection molding, or with the help of leather wrap, or by dipping the armature in thermally or chemically curable substance, and so forth. Optionally, the second protective layer can change color depending upon the temperature of the substrate, there by giving visual indication of temperature of steering wheel.

The thermal management can include heating and/or cooling. For example, the heating element can be used to cool the steering wheel by reversing the flow of current as in thermoelectric effect. This can be achieved by using two dissimilar materials (e.g., p-type and n-type) along with the ink Alternatively, or in addition, if a fluid is passed through the armature, the fluid can be heated or cooled in order to thermally adjust the armature.

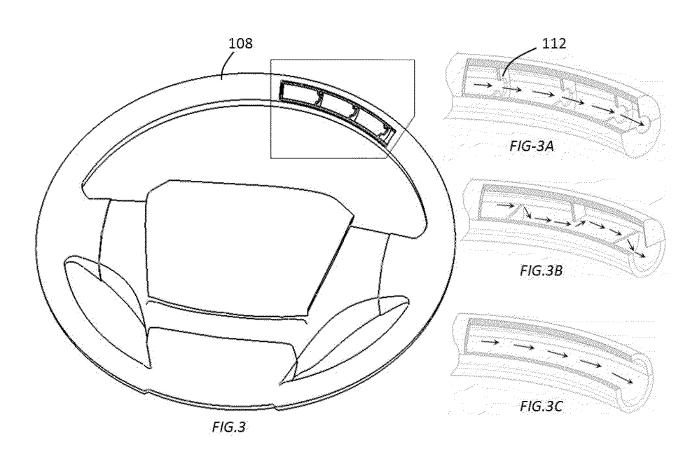

In the embodiments illustrated in FIGS. 3, 3A, 3B, 3C, 4, 4, 4A, 6, 6A and 6B, a fluid (such as gas, e.g., air), is diverted through the armature, e.g., through a channel, pipe, or the like to enable thermal management. This thermal management can be used independently or in conjunction with the heater element discussed above. Here, for example, air can be diverted from the HVAC system through the steering wheel, and optionally out of the armature to the operator's hands.

In this embodiment, a thermally regulated medium (e.g., a liquid or gas) is allowed to flow inside the hollow thermoplastic armature which will regulate the steering wheel temperature, e.g., air from the HVAC system is forced inside the hollow thermoplastic steering wheel armature to regulate the temperature of the steering wheel. For example, an integrated channel can be built inside the steering wheel armature from the hub to spoke region for diverting the air from the HVAC system.

The hollow section of the armature can be designed to have obstructions to airflow to create turbulence to air flow to improve the heat transfer efficiency. Surface texturing towards the airside of the plastic hollow section can be employed to break the boundary layer of the airflow. This can enhance the heat transfer efficiency by increasing convection heat transfer surface area. Radiation heat transfer can also be increased with a diffuse surface (scattering effect). The rim of the rib can have multiple openings for airflow. Optionally, an infrared (IR) absorbing coating can be provided on the airside of the pipe to further increase the heat transfer efficiency.

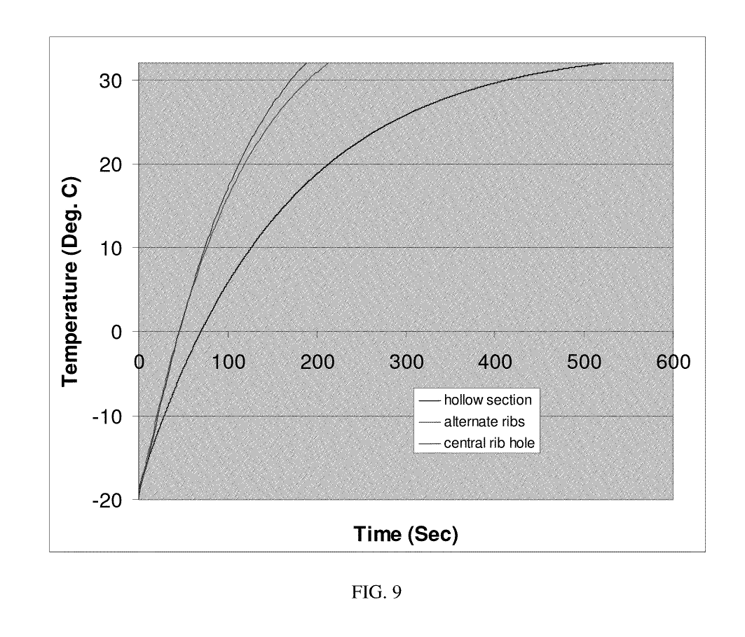

Through design, the airflow path can reduce the flow-induced noise while capturing enough turbulence for enhanced heat transfer. A design such as in FIG. 3A, e.g., where the flow area converges and diverges (e.g., between the ribs versus passing through the ribs), flow direction and velocity and be changed further enhancing heat transfer. With a design such as in FIG. 3B, flow direction is changed, which enhances heat transfer compared to a design with no change in flow direction, but not as much as where both flow direction and velocity are adjusted. (Refer to FIG. 9) In FIG. 3A, a central rib opening is illustrated. However, an off-set rib opening is also contemplated, as well as a variety of opening geometries (circular, oval, polygonal, combinations thereof, and other). The arrows in FIGS. 3A-3C illustrate the fluid flow direction.

Desirably, the flow path through the rim has a design (e.g., obstructions) that, when in use, fluid flowing therethrough changes in direction and/or velocity, and/or turbulence is created. Examples of designs to enable a change in flow velocity and/or direction include ribs, changes in flow area (e.g., converging and diverging flow path area).

In single piece armature a flexible conduit of suitable material can be inserted to create a hollow section that will not break during steering wheel bending and torsion and during manufacturing process. The hollow conduit will decrease the amount of over molded foam, thus can reduce the weight of the steering apparatus.

Optionally, thermally conductive additives can be added to the thermoplastic material of the steering wheel to enhance the rate of heat transfer in the armature.

For example, a base annular steering wheel is molded of an engineered thermoplastic (e.g., polycarbonate) having grooves then an electrically conductive thermoplastic is second shot molded into the grooves, e.g., to form a hybrid steering wheel. The wheel can also be covered with a protective material (e.g., foam, vinyl, leather, fabric, and so forth).

These steering wheel systems can be made by various molding processes, such as an injection molding process. For example, in the case of the multi-piece solution the different halves can be injection molded and joined together through various joining process (e.g., vibration welding, spin welding, swaging, cold heading, adhesive, and/or thermal welding and so forth) The grooves can also be directly injection molded and can also be produced through secondary manufacturing process (e.g., machining, hot stamping, and so forth). On making single piece hollow steering wheel armature, it can be through regular gas assisted injection molding with or without overflow wells or with water assisted injection molding process.

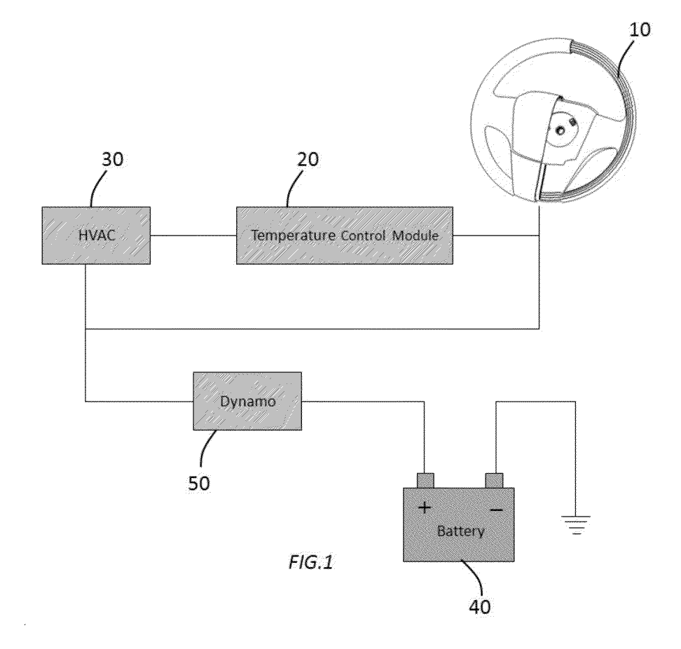

Referring to the Figures, FIG. 1 is a schematic view of an exemplary heated steering wheel (“SW”) system. This system can be employed with any of the various embodiments of heated steering wheels systems discussed herein. As can be seen from the schematic, the steering wheel 10 can be in operable communication with a temperature control module (20) and/or with the heating, ventilation, air conditioning system 30. The steering wheel system can be in electrical communication with the vehicle battery 40 and/or with dynamo 50 for the supply of all needed power.

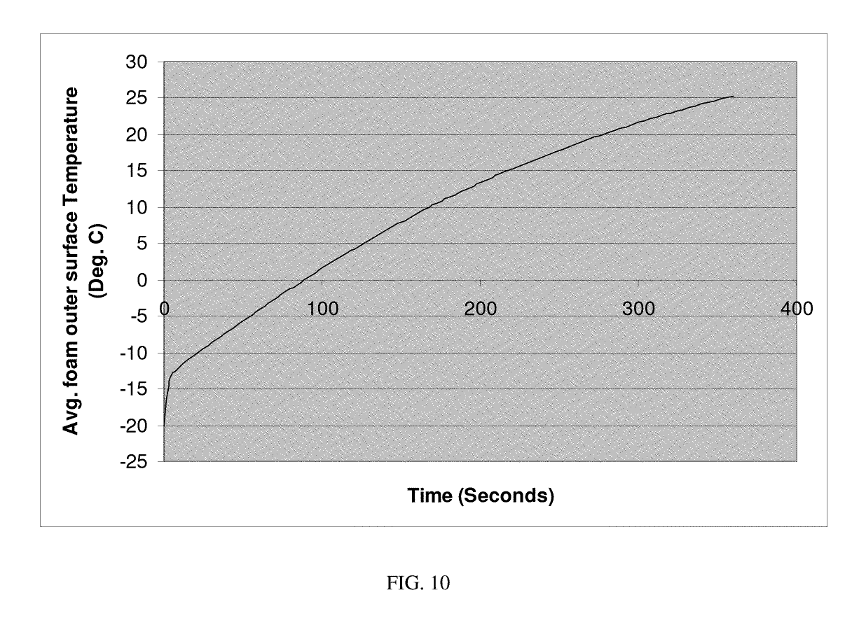

FIGS. 2-7B are directed to the various embodiments of the steering wheel, wherein the elements thereof can be interchanged. FIG. 2, for example, illustrates a steering wheel comprising a plastic (e.g., thermoplastic) core 102 with a heater disposed thereon 104. The heater can be disposed onto the core 102, and optionally into grooves formed 412 in the core 102 for receiving the heater 104. Optionally disposed around the core is a protective covering 106, e.g., foam, leather, vinyl, or the like. FIGS. 2A-2C illustrate examples of heater trace designs. The designs, e.g., patterns, can be used alone or in combination. For example, the degree of heating can be enhanced in a particular area by increasing the amount of heater elements in the particular area, e.g., by using a wavy design (FIG. 2B), zigzag design, criss-cross design (FIG. 7), parallel designs (FIGS. 2A and 2C), lines, waves, grids, spiral, circular along the steering wheel armature, and combinations comprising at least one of the foregoing (e.g., FIG. 2). FIG. 2C also illustrates a heater trace to a busbar that can connect the heater elements to an electrical source. FIG. 10 is a graphical representation of the average surface temperature on a steering wheel rim versus time for a plastic rim with a printed heater circuit on the rim with a foam outer surface starting from a temperature of −20° C. at a heat energy supplied through the printed circuit of 20 W.

FIG. 3 is a partial, cut-away view of another embodiment of a steering wheel, while FIG. 3A is an expanded view thereof, which can be formed in a single or multiple (e.g., 2 or more), pieces with a channel therethrough. The wheel can have ribs 112 with an opening therethrough to allow fluid flow. In the multi-piece designs, the ribs can be designed to assist in connection of the pieces together. As noted above, this embodiment can be used alone, or in conjunction with the heater discussed in other embodiments.

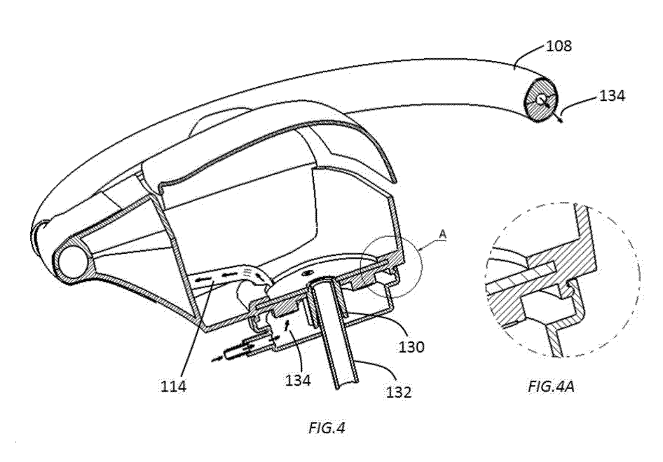

FIG. 4 is a cross-sectional, perspective view of an embodiment of a steering wheel system with fluid flow therethrough as is illustrated in FIG. 3. This figure further illustrates the hub 130 that connects the wheel 108 to the shaft 132, thereby enabling the wheel 108 to rotate and to thereby steer the vehicle. Also illustrated in this figure is an embodiment of the connection from the wheel 108 to the vehicle HVAC system, e.g., through conduit 114. Arrows 134 illustrate the fluid flow from the HVAC system, through the conduit 114 and through the wheel 108.

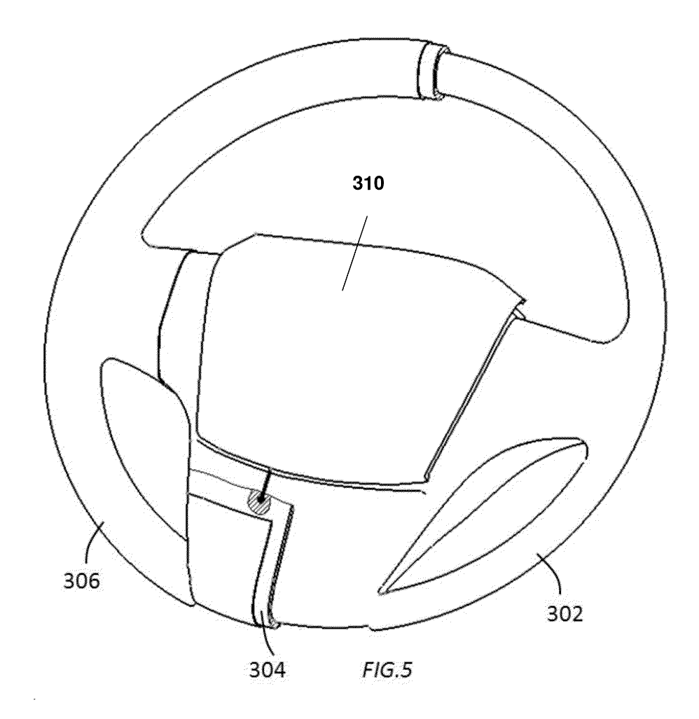

FIG. 5 is a cut away perspective view of another embodiment of a steering wheel with electrically and thermally conductive foam located around an engineered core. The core 302 can be any design set forth herein (e.g., with or without the perforations, with or without the channel,). Disposed around the core 302 is an electrically conductive foam 304. The foam, which is electrically conductive and optionally thermally conductive, is also useful in the various embodiments disclosed herein. The steering wheel system can include an optional airbag 310.

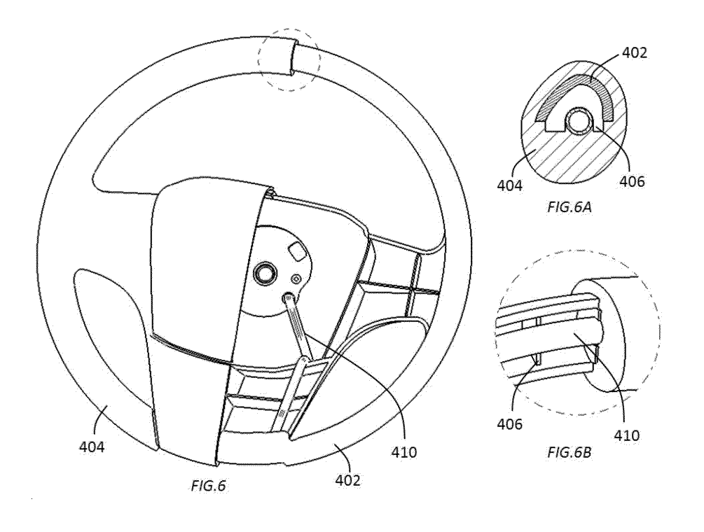

FIG. 6 is a front, cut away perspective view of another embodiment of a steering wheel, i.e., the single piece steering wheel, that uses a conduit (410) (e.g., flexible tube(s)) to enable fluid to flow through the steering wheel. FIG. 6A is a cross-sectional view of the steering wheel illustrating the arrangement of the plastic core, conduit, and covering in FIG. 6. FIG. 6B is a rearside, cut away view illustrating the plastic core, conduit, and covering from FIG. 6. In this embodiment, the core 402, foam 404, and conduit 410 are molded into a single, one piece element (e.g., that cannot be disassembled). In other words, the core is made up of single piece in the armature area. The core 402 extends around only a portion (e.g., less than or equal to 70%, specifically less than or equal to 55%) of the outer surface of the conduit 410. Here, the core 402 can have rib(s) 406 extending from the core 402 toward the conduit 410, e.g., to provide further structural integrity. Disposed around the core 402 and the conduit 410, is a structural foam 404. Although the rib(s) may extend from the core 402 to the conduit 410, in the remaining areas between the core 402 and the conduit 410 is the foam 404.

In single piece construction, ribs can be employed on the back side (e.g., the side that will be located closest to the dashboard, away from the operator) to stiffen the steering wheel so that it can perform and meet all the requirements of steering wheel. In addition, these ribs can optionally be used to hold the flexible conduit in place by suitably modifying the design. Then this sub assembly can be kept inside the mold and foamed. The material for conduit should be capable of withstanding the foaming pressure and temperature without getting distorted or failing during the manufacturing process. Once foam solidifies, it forms an integral structure which cannot be disassembled without damaging the foam. While foaming, care should be taken to prevent foam entering the conduit which will block the fluid passage.

A two piece construction is illustrated in FIGS. 7A and 7B. As can be seen, the first portion 416 and second portion 418 with a connector 420 (e.g., mechanical attachment (such as a snap connector, rivet, screw, and so forth), and chemical attachment (such as bonding agent, and so forth)).

The various designs disclosed herein enable efficient, effective thermal control of the steering wheel. Advantages of the present designs include ease of manufacturing, light weight design, a fewer number of parts in some designs, and/or a simpler design for the circuits. Actually, compared to a magnesium armature with an electrically conductive second shot, wherein the thickness of the magnesium steering wheel is 6 mm and the thickness of the plastic steering wheel (plastic armature and plastic second shot), the plastic steering wheel reaches a comfort temperature of 23° C. from −20° C. in less than half the time (e.g., 16.2 minutes versus 34.5 minutes). Additionally, with the same design rim, the plastic steering wheel has a more uniform heating across the periphery of the rim than a magnesium steering wheel.

In an embodiment, a steering wheel system can comprise: an armature comprising a rim comprising a plastic core, a covering between the plastic core and the protective outer layer, and a thermal management provision; a hub with a bush; and a spoke connecting the rim to the hub.

In an embodiment, a method for making a thermal management steering wheel can comprise: forming a plastic rim with a core having a channel with ribs, wherein during use, the ribs induce a change in direction and a change in velocity of a fluid flow through the channel; laser direct structuring electrically conductive material onto the core; disposing a foam material around the core; and disposing a protective material around the foam material.

In the various embodiments set forth above, (i) wherein the core a fluid flow channel that allows fluid to flows through the rim, such that, when in use fluid can flow through the channel to change a rim temperature; and/or (ii) wherein the fluid channel is in fluid communication with a vehicle HVAC system; and/or (iii) wherein the core has a channel therethrough, and has ribs extending into the channel, wherein a fluid can flow through the channel; and/or (iv) wherein the ribs have an opening to allow the fluid flow through the ribs; and/or (v) wherein the channel has a design to enable the turbulent flow of fluid through the channel; and/or (vi) wherein ribs are oriented in a staggered manner around the channel; and/or (vii) wherein during use, the ribs create changes in direction and velocity of the fluid flow; and/or (viii) wherein during use, the ribs create a converging and diverging flow path area; and/or (ix) further comprising a heating element located in a groove in the surface of the plastic core; and/or (x) wherein the covering comprises an electrically conductive foam; and/or (xi) further comprising electrically conductive heater traces located directly over the core in a pattern; and/or (xii) wherein the pattern is selected from the group consisting of lines, waves, grids, zigzag, spiral, circular, and combinations comprising at least one of the foregoing; and/or (xiii) wherein the steering wheel has no metal core, metal coating, or metal support structure; and/or (xiv) wherein only a hub and a bush of the steering wheel system comprise metal; and/or (xv) wherein the armature is a single component with an integrally formed channel through the rim; and/or (xvi) wherein the rim is a clam-shell design comprising two pieces that attach together to form a channel through the rim.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combination” is inclusive of blends, mixtures, alloys, reaction products, and the like. Furthermore, the terms “first,” “second,” and the like, herein do not denote any order, quantity, or importance, but rather are used to d one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A steering wheel system, comprising:
an armature comprising
a rim comprising a plastic core, a covering between the plastic core and the protective outer layer, and a thermal management provision;
a hub with a bush; and
a spoke connecting the rim to the hub.

2. The steering wheel system of claim 1, wherein the core comprises a fluid flow channel that allows fluid to flows through the rim, such that, when in use fluid can flow through the channel to change a rim temperature.

3. The steering wheel system of claim 2, wherein the fluid channel is in fluid communication with a vehicle HVAC system.

4. The steering wheel system of claim 2, wherein the core has a channel therethrough, and has ribs extending into the channel, wherein a fluid can flow through the channel.

5. The steering wheel system of claim 8, wherein the ribs have an opening to allow the fluid flow through the ribs.

6. The steering wheel system of claim 2, wherein the channel has a design to enable the turbulent flow of fluid through the channel.

7. The steering wheel system of claim 6, wherein ribs are oriented in a staggered manner around the channel.

8. The steering wheel system of claim 6, wherein during use, the ribs create changes in direction and velocity of the fluid flow.

9. The steering wheel system of claim 6, wherein during use, the ribs create a converging and diverging flow path area.

10. The steering wheel system of claim 1, further comprising a heating element located in a groove in the surface of the plastic core.

11. The steering wheel system of claim 1, wherein the covering comprises an electrically conductive foam.

12. The steering wheel system of claim 1, further comprising electrically conductive heater traces located directly over the core in a pattern.

13. The steering wheel system of claim 12, wherein the pattern is selected from the group consisting of lines, waves, grids, zigzag, spiral, circular, and combinations comprising at least one of the foregoing.

14. The steering wheel system of claim 1, wherein the steering wheel has no metal core, metal coating, or metal support structure.

15. The steering wheel system of claim 1, wherein only a hub and a bush of the steering wheel system comprise metal.

16. The steering wheel system of claim 1, wherein the armature is a single component with an integrally formed channel through the rim.

17. The steering wheel system of claim 1, wherein the rim is a clam-shell design comprising two pieces that attach together to form a channel through the rim.

18. A method for making a thermal management steering wheel, comprising:
forming a plastic rim with a core having a channel with ribs, wherein during use, the ribs induce a change in direction and a change in velocity of a fluid flow through the channel;
laser direct structuring electrically conductive material onto the core;
disposing a foam material around the core; and
disposing a protective material around the foam material.

19. The method of claim 16, further comprising forming grooves across a surface of the rim and forming heater traces in the grooves.
